(19) United States
(12) Patent Application Publication
(10) Pub. No.: US 2006/0131831 A1
(43) Pub. Date: Jun. 22, 2006

(54) Kick n Go lightning bolt skateboard

(76) Inventor: Agustin Carmona, Miami, FL (US)

Correspondence Address: Agustin Carmona, 12914 N.W. 8TH Lane, Miami, FL, 33182, US

(21) Appl. No.: 11/016,591

(22) Filed: Dec. 20, 2004

(51) Int. Cl. B62M 1/00

(52) U.S. Cl. 280/221

(57) ABSTRACT

A revolutionized skateboard consisting of a thick platform (10) accomodating a transmission pedal (12), a toothed v-shaped rod (12D), a brake pad (14), two ratchet gears (30) a toothed rod (28C), two box springs (12B), a toothed wheel (28) and five wheels (26) incorporated into a transmission system. Also accomodating two wheel and suspension brackets (20) and (22), four toothed suspension rods (20B), a pair of suspension gears (24) incorporated into a suspension system. A roller bar (18) setup for those that perform tricks.

### CROSS REFERENCE TO RELATED APPLICATIONS

NOT APPLICABLE

### FEDERALLY SPONSORED RESEARCH

NOT APPLICABLE

### SEQUENCE LISTING OR PROGRAM

NOT APPLICABLE

### BACKGROUND OF THE INVENTION

1. Field of Invention

This invention relates to skateboards, specifically to an improved redesigned skateboard.

2. Discussion of Prior Art

Originally skateboards were made with a fixed wheel base. This made taking curbs or quick sharp turns difficult, causing the skateboard to slide causing injury or accidents. This problem has never been approached. Also when one rides a skateboard to gain momentum, one has to kick off the surface. By placing a foot on the and kicking off the amount of momentum is limited to the quickness of ones kickoff. And the amount of pressure applied.

And to conclude most people use skateboards. For example some use the middle of the bottom part of the skateboard. To slide down across railings, curbs, etc, wearing down the skateboard.

### OBJECTS AND ADVANTAGES

Accordingly, several objects and advantages of my invention are:

(A) to provide a skateboard with a suspension system to handle sharp turns or curbs;

(B) to provide a skateboard that eliminates the pushing off the ground for momentum;

(C) to provide a skateboard that you can board and go without the need to touch the ground with your feet;

(D) to provide a skateboard equipped with roller bars to perform tricks.

Further objects and advantages are to provide a skateboard that can be used easily and conveniently. By people of most any age. Still further objects and advantages will become apparent from a consideration of the ensuing description and drawings.

### SUMMARY

In accordance with the present invention a skateboard comprises a platform, a suspension system and a transmission system.

### DRAWINGS

In the drawings, closely related figures have the same number but different alphabetic suffixes.

FIG. 1 shows a perspective view of the invention; and an operational view.

FIG. 1A shows an illustration of moving parts.

FIG. z shows a perspective view of the invention, and an operational view.

FIG. 3 shows an internal view of a part.

FIG. 3 shows an exploded view of the invention.

FIG. 4 shows an operational views of the invention.

### DRAWINGS—LIST OF REFERENCE NUMERALS

10 platform
10A mount hole
10B mount hole
12 transmission pedal
12A mount hole
12B box spring
12C fastening screw
12D toothed v-rod
12E mount hole
14 brake pad
14A mount hole
14B fastening screw
16 roller bar braket
16AA roller bar bracket
16A fastening bolt
16B mount hole
16C mount hole
18 roller bar
18A bearing box
18B fastening bolt
20 wheel and suspension bracket
20A mount hole
20B toothed suspension rod
20C mount hole
20D fastening bolt
22 wheel and suspension bracket
22A rectangular casings
22B mount plate
22C mount holes
24 suspension gear
24A fastening screw
26 wheel
26A bearing box
26B fastening screw
28 toothed wheel
28AA wheel
28A bearing box
28B fastening screw
28C toothed rod
30 ratchet gear

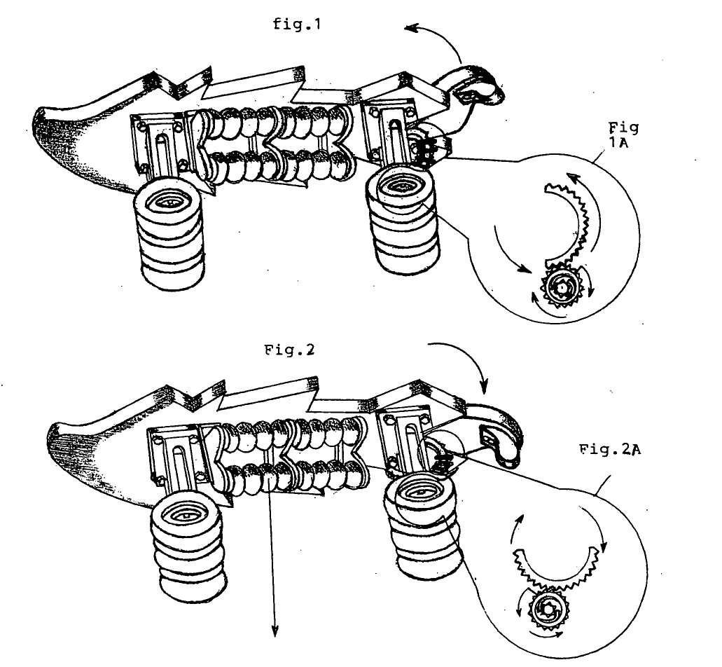

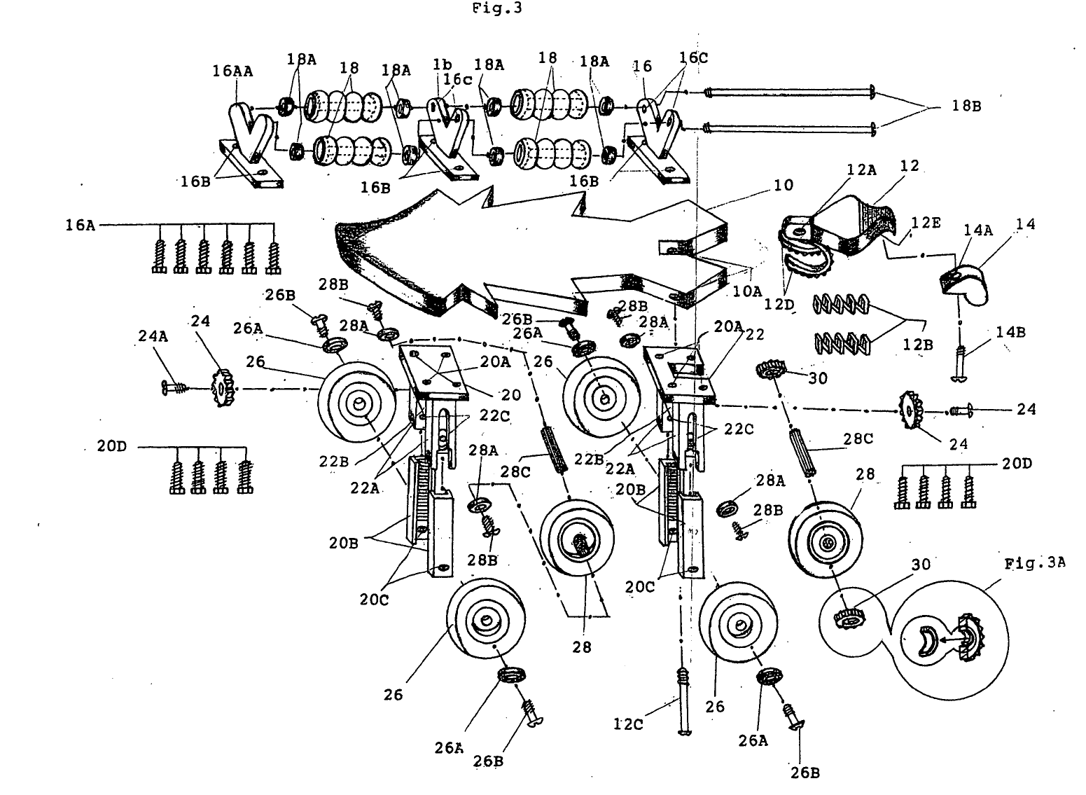

### DETAILED DESCRIPTION—PREFERRED EMBODIMENT—FIGS. 1 AND 3

A preferred embodiment of the present invention is illustrated in (FIG. 1). The skateboard has thick platform 10 consisting of a durable material. At the tail end of the platform 10 is a square cut out and a mount hole 10A. The mount hole 10A runs through the tail end from the left side of the outter tail through the inner right side ending in a female coupling. The platform 10 a series of 14 mount hole 10B on the bottom of the platform 10. On the bottom back end is fastened a wheel and suspension bracket 22 fastened on to four mount holes 10B with a series of four fastening bolts 20D.

The wheel and suspension bracket 22 consists of a base with a square cut out on the back end. Attached to the wheel and suspension bracket 22 is a pair of hollow rectangular casings 22A with a mount hole 22C with a circular groove around it on the inner side.

On the top of left and right rectangular casings is a square opening. On the outter right of the left rectangular casing 22A and the left of the outter right rectangular casing 22A is a pair of stems at the wheel height and one under at a ratchet gear 30 height. On the outter sides is a square notch, starting at the bottom thinning out into a round out. On the front side of the wheel and suspension bracket 22 is a thin mount plate 22B between the rectangular casings 22A with a mount hole with a female coupling.

A toothed wheel 28 rounded at its top and bottom with a toothed hole in the center. The toothed wheel 28 accomadates a toothed rod 28C. The toothed rods 28C ends have a cavity with a female coupling. The toothed rod 28C slides through the center of the toothed wheel 28. Followed by a pair of ratchet gears 30. The ratchet gears 30 are toothed at the center.

On the inside of the ratchet gears are teeth with two levers one to the top and one to the bottom ending on the teeth. One ratchet gear 30 slides on from one side of the toothed rod 28C the other ratchet gear 30 from the opposing side. Flush with the toothed wheel 28. The toothed wheel 28 is fastened to the wheel and suspension bracket 22 from the inside of the rectangular casings 22C. In between the rectangular casings fastened on with a bearing box 28A, followed by a fastening screw 28B. The bearing box fits right into the circular groove around the mount hole 22C.

A pair of toothed rods 20B have a groove running down the middle of the toothed rod 20B. From the top of the groove to the adjacent end are teeth, below where the teeth end is a mount hole 20C with a female coupling. A pair of wheels 26 with a hole running through the middle, with a circular groove around the hole. Are fastened on each of the toothed suspension rods 22B through the outside. Fastened on first with a bearing box 26A accomadated in the circular groove of wheel 26. Followed by a fastening screw 26B. The toothed suspension rods 20B slide into the rectangular casings 22A, the wheels 26 on the outside.

There locked in place with a suspension gear 24 through the square opening on the rectangular casings 22A. The suspension gear 24 is fastened to the mount plate 22B with a fastened screw 24A. A transmission pedal 12 with a pair of toothed v-shaped rods 12D is attached to the front on the bottom under a mount hole 12A. On the back of the top is a non slip grip. The transmission pedal 12 on the bottom of the back is a mount hole 12E. On the two toothed v-shaped rods 12D, slide on a pair of box springs 12B.

The toothed v-shaped rods 120 are placed in between the stems on the rectangular casings 22A. Positioning the mount hole 12A in between the mount holes 10A at the back end of the platform 10A, Fastened in place with a fastening screw 12C. On the mount hole 12E on the bottom of the back of the transmission pedal 12 is fastened a brake pad 14. It is fastened on with a fastening screw 14B. On the bottom of the front of the platform 10 are four mount holes 10B. Fastened to the mount holes 10B is a wheel and suspension bracket 20 fastened on with four fastening bolts 20D. The wheel and suspension bracket 20 A consists of a base with four mount holes 20A. Attached to the bottom of the base are two hallow rectangular casings 22B. The rectangular casings 22B on the outter sides have a square notch starting at the bottom thinning out into a round end.

On the inner sides is a mount hole 22C with a circular groove around it. At the front in between the rectangular casings 22A is a mount plate 22B with a mount hole in the center with with a female coupling. On the outter right of the left rectangular casing 22A and the outter left of the right rectangular casing 22A is a square notch centered in the mount hole on the mount plate 22B. In between the rectangular casings 22A is fastened a wheel 28AA. The wheel 28AA has a hollow toothed rod running through the middle of it, the teeth are in the inside. Around the hollow toothed rod is a circular groove. The toothed rod 28C slides into the hollow toothed rod.

The wheel 28AA is fastened in between the rectangular casings 22A from the inside of the rectangular casings 22A. With the bearing box 28A followed with the fastening screw 28B. The wheels 26 are fastened to the outter sides of the toothed suspension rods 20B with the bearing box 26A followed by the fastening screw 26B. The two toothed suspension rods 20B slide into the rectangular casings, wheels 26 on the outside. There locked in place with the suspension gear, which is fastened to the mount plate 22B with the fastening screw 24A.

In between the mounted wheel and suspension brackets 20 and 22 on the bottom of the platform 10 are six mount holes 10B. Two in the front two in the middle and two in the back. Fastened to the front two mount holes 10B is a roller bar bracket 16AA. The roller bar bracket 16AA consists of a set of a mount holes 16B on a base, a v-shaped plate with a female coupling at its tips on the backside. The roller bar bracket 16AA is attached to the platform 10 with a pair of fastening bolts 16A. A roller bar bracket 16 is fastened in the middle of the platform 10 with two fastening bolts 16A. The roller bar bracket 16 is fastened in front of the wheel and suspension bracket 22 with two fastening bolts 20D.

A roller bar 18 consisting of a cavity running through it with a cut out groove at the openings. Four roller bars 18 are fastened to the roller bar brackets 16AA and 16. Two on the front and two on the back. A bearing box 18A is placed in each of the cut out grooves of the roller bars 18. To fasten the roller bars 18, start from the back. Placing one roller bar in between the mount holes 16C on the roller bar brackets 16. Sliding an elongated fastening screw 18B through the mount hole 16C on the rear roller bar bracket 16 through the roller bar 18.

### OPERATION OF INVENTION—FIGS. 1, 1A, 22A AND 4

The manner of using the Kick n Go Lightning Bolt is different to that of skateboards in present use. Namely, one first boards the skateboard. One places one foot to the front of the platform 10 and one to the back of the platform 10 on the transmission pedal 12. Then, one pumps down the transmission pedal. Which in turn rakes the teeth of the toothed v-rod 12 on the teeth of the ratchet gear 30. By raking of the ratchet gear 30. It moves the ratchet gear 30 in a positive motion. Which in turn moves the toothed rod that moves the wheel 28 as illustrated in (FIG. 2A). Propelling the skateboard forward.

One then releases the pressure applied to the transmission pedal 12. The box springs 12B are pushed against the stems on the rectangular casings 22C. When pressure is released the box springs 12B push the transmission pedal 12 back to the starting position. In the process of pushing back, the ratchet gears 30 free spin in a negative motion due to the two levers and the teeth in the inside of the ratchet gears 30. That allows the toothed v-shaped rods to move as illustrated in (FIG. 1A). To gain momentum and speed one continously pumps down the transmission pedal 12. The process repeats itself. The faster one pumps down on the transmission pedal 12 the more speed one achieves. All other five wheels spin freely.

The skateboard is equipped with a suspension system. While in motion the skateboard maintains a level position when one is approaching a turn or a sudded turn is needed. To avoid the skateboard sliding sideways or wiping out. By leaning to the left or the right, the suspension system adjusts the wheels 26. When leaning to the left the outter left wheels 26 and the left toothed suspension rods 20B slide up into the rectangular casings 22A. The teeth of the toothed suspension rod 20B move the teeth of the suspension gear 24.

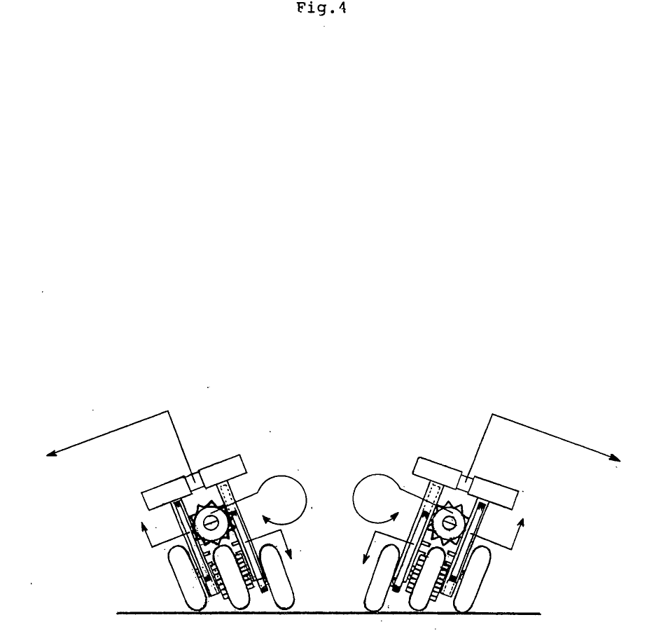

Turning it in a clockwise motion which moves the right side toothed suspension rods 20B and wheels 26 down and out as illustrated in (FIG. 4) occuring simultaneus at the front as well as the back. When leaning to the right the right side toothed suspension rods 20B slide up into the rectangular casings 22A. The teeth of the right toothed suspension rod 20B, move the suspension gear 24 on a counter clockwise motion. That then moves the left toothed suspension rods 20B down. Due to the roundness of the wheels 26 and 28 at their top and bottom sliding is avoided.

The roller bars 18 are for the use of those that like to perform certain tricks. Like sliding down or across railings, curbs, etc. The roller bars 18 eliminate the wear and tear that skateboards in present use recieve. The roller bars 18 act as tiny wheels which make it easier to slide down or across the surfaces that one chooses.

I claim:

1. A self-propelled skateboard, comprimising:
a. a body platform having rotatable wheels mounted on said platform to roll along a surface,
b. a system mounted on said platform for producing rotational energy, and
c. means for controllably coupling rotational energy from said system to at least one of said wheels,
whereby said platform will be self-propelled along said surface.
